(19) United States
(12) Patent Application Publication
(10) Pub. No.: US 2026/0024932 A1
(43) Pub. Date: Jan. 22, 2026

(54) CONNECTOR AND RELATED PRODUCTION METHOD

(71) Applicant: Silvano TAGLIETTI, Coccaglio (IT)

(72) Inventor: Silvano TAGLIETTI, Coccaglio (IT)

(21) Appl. No.: 19/270,861

(22) Filed: Jul. 16, 2025

(30) Foreign Application Priority Data
Jul. 17, 2024 (IT) 102024000016600

(51) Int. Cl. H01R 12/72; H01R 12/70; H01R 13/207; H01R 13/512; H01R 13/623

(52) U.S. Cl. CPC H01R 12/722; H01R 12/7047; H01R 13/207; H01R 13/512; H01R 13/623

(57) ABSTRACT

A connector having a connection element configured to couple with a coaxial cable, the connection element including a body that houses a signal-transmission portion, an interface body connectable with the connection element and including a through-hole for the passage of the signal-transmission portion coming from the connection element, and a matching element configured to mechanically couple with the interface body and cause, when coupled with the interface body, the clamping of a board associable with the connector and adapted to receive the signal of the signal-transmission portion. The matching element includes at least two coupling elements and the interface body includes at least two respective housing seats configured to receive and engage with the coupling elements, the housing seats being configured to allow a guided sliding of the coupling elements therein.

### FIELD

The present invention relates to a connector and a related production method, said connector being used, for instance, to connect a coaxial cable (intended, for instance, to carry signals in the microwave domain) to a board on which a microstrip line is formed. The following description is made with reference to this field of application with the sole aim of simplifying the explanation.

### BACKGROUND

As it is well known, coaxial cables are used in a wide variety of applications and are capable of carrying signals at very high frequencies, including signals in the microwave range.

In this field, there are connectors capable of interfacing the high-frequency signal carried by the coaxial cable with a microstrip line formed on a printed circuit board (referred to in the industry as PCB, an acronym for the term “Printed Circuit Board”). More specifically, the microstrip line is a type of waveguide used for the guided propagation of electromagnetic waves in the microwave range or at even higher frequencies, and consists of a metal ground plane and a strip of conductive material of smaller width, separated by a layer of dielectric material.

Generally, connectors of this type comprise a connection element (for instance tubular-shaped) comprising a coupling portion (which may be of the male or female type) for coupling with a coaxial cable, and a flange element for clamping the board, so that the signal from the coaxial cable is first transferred to the conductive pin of the connector and then from that conductive pin to the microstrip line.

However, many known solutions are limited by the poor mechanical strength of the connectors, which often have a disadvantageous relative movement of their components, resulting in incorrect clamping of the board and consequently significant losses in the high-frequency signal to be transmitted.

It should also be noted that, in known solutions, the microstrip line must be manually centred on the conductive pin of the connector, which is often difficult and prone to errors during assembly.

Finally, it should be noted that known solutions involve the manufacture of connectors of the above type using very expensive methods, such as through numerically controlled machines.

The technical problem of the present invention is to devise a connector having structural and functional features such as to overcome the limitations and drawbacks complained of in relation to known solutions, in particular having a robust mechanical structure and ensuring effective interfacing between a coaxial cable and a microstrip line for the transmission of the signal coming from said coaxial cable.

Another purpose of the present invention is to reduce the production costs of a connector of the above type.

### SUMMARY

The idea underlying the present invention is to provide a connector, advantageously formed by die casting, in which a matching element (also referred to as a “carriage” or “clamping element”) can be inserted in a guided manner into a flange element (hereinafter also referred to as an “interface body” or “transition block”) by means of a pair of coupling elements, for instance in the form of pins extending from a plate, which slide telescopically in respective guides formed in said flange element, thereby clamping a PCB board on which a microstrip line is formed for transmitting a high-frequency signal from a cable (associated with the connector) to said microstrip line. In some advantageous embodiments, an intermediate plate is also provided, which allows the PCB to be correctly positioned and, if necessary, bears means for centring the PCB.

Based on this solution idea, the above technical problem is solved by a connector comprising a connection element configured to couple with a coaxial cable, said connection element comprising a body that houses a signal-transmission portion (or transmission line), an interface body connectable to the connection element and comprising a through-hole for the passage of the signal-transmission portion coming from said connection element, and a matching element (also referred to as a “clamping element”) configured to mechanically couple with the interface body and determine, when coupled with said interface body, the clamping of a board that can be associated with said connector and is adapted to receive the signal of the signal-transmission portion, wherein the matching element comprises at least two coupling elements and the interface body comprises at least two respective housing seats configured to receive and engage with the coupling elements, said housing seats being configured to allow guided sliding of said coupling elements therein.

More particularly, the invention comprises the following additional and optional features, taken individually or in combination as required. These features are described, for instance, in the dependent claims.

According to an aspect of the present invention, the coupling elements and the housing seats may be arranged symmetrically in respective positions with respect to the through-hole of the interface body, said respective positions being at a given distance from said through-hole.

In particular, the through-hole may be arranged in a position that is between the housing seats (for example at a same distance between said housing seats, that is, in the middle), more particularly it is located along an axis that is parallel and arranged between the longitudinal axes of said housing seats.

According to an aspect of the present invention, the matching element may comprise a base plate which the coupling elements extend from (substantially in the form of pins).

This is very advantageous, since it allows better mechanical stability of the connector, wherein the matching element is inserted in the connection element in a perfectly guided way, without transversal clearance; this also facilitates the centering of the board. This allows the matching element to slide (for example in a telescopic way) in a guided way with great stability and without central obstacles, since the housing seats and the coupling elements (which may be pins) are not in the center, but are spaced apart and the through hole is arranged between them.

According to an aspect of the present invention, the matching element may also comprise threaded holes, formed on the above base plate, adapted to receive screws adapted to fasten the interface body and the matching element to each other.

According to an aspect of the present invention, the coupling elements may be in the form of pins extending from the base plate along an axis substantially orthogonal to said base plate, in particular a vertical axis.

According to an aspect of the present invention, the aforementioned pins may have the shape of a cylinder extended along said vertical axis (cylindrical shape).

According to another aspect of the present invention, the coupling elements may be elements protruding from the base plate and may have a thickness substantially equal to that of said base plate, i.e. they do not extend vertically more than said base plate.

According to an aspect of the present invention, the matching element can be telescopically connected to the interface body, with consequent possibility of adjustment of extent of insertion by telescopic sliding of the coupling elements within the housing seats (i.e. the extent of insertion by sliding is thus adjustable).

According to an aspect of the present invention, the position of the base plate of the matching element relative to the interface body can be defined by screws screwed in the threaded holes formed in said base plate, in particular it can be selected/defined by the screws (in particular by their length along the aforementioned axis) that can be screwed in said threaded holes. Therefore by changing the screw the distance changes, and the carriage can slide telescopically.

According to an aspect of the present invention, the housing seats can be recesses formed in the interface body and the coupling elements can be in the form of projections housed in said recesses.

According to an aspect of the present invention, the coupling elements and the housing seats may have shapes complementary to each other.

According to an aspect of the present invention, the connector may comprise first centering means configured to engage with respective reference portions of the board and to force, when the matching element and the interface body are connected (constrained) to each other (for instance via the above screws), said board in a reference position, in which the microstrip line is in a central position. The first centering means are different from the screws adapted to fasten the interface body and the matching element to each other.

According to an aspect of the present invention, the first centering means may include at least two elements protruding from the base plate of the matching element, said protruding elements acting as reference elements configured to engage with the corresponding reference portions on the board (which in this case correspond to the holes for the passage of the fixing screws).

According to an aspect of the present invention, the protruding elements may be in the form of cones formed around the threaded holes of the base plate and configured to be inserted into respective holes of the board.

According to an aspect of the present invention, the connector may comprise an intermediate plate arranged between the base plate of the matching element and a surface (also referred to as a “matching surface”) of at least one shoulder of the interface body, said intermediate plate comprising through-holes adapted to allow the passage of screws for fastening the interface body and the matching element with each other.

According to an aspect of the present invention, the intermediate plate may comprise second centering means configured to engage with respective reference portions of the board and to force said board in a reference position when the matching element and the interface body are fastened with each other and said board is arranged between said intermediate plate and the surface of the interface body. The second centering means are different from the screws adapted to fasten the interface body and the matching element to each other

According to an aspect of the present invention, the second centering means of the intermediate plate may include a pair of cones configured to be inserted into respective holes of the board (i.e., the holes for the passage of screws), said cones being formed around through-holes of said intermediate plate.

According to an aspect of the present invention, the second centring means of the intermediate plate may be a pair of protruding pins configured to engage in corresponding reference holes (which are therefore alternative reference portions on the board) formed on the board, said protruding pins being placed in respective positions shifted with respect to the through-holes of said intermediate plate.

According to an aspect of the present invention, the protruding pins may have at least their free end portion having a conical or tapered shape, whereas the base attached to the plate is cylindrical-shaped and has a diameter equal to that of the reference holes on the board. According to an aspect of the present invention, the matching element may comprise cones protruding from the base plate and formed around threaded holes in said base plate, and the intermediate plate may comprise seats configured to engage with said cones of the matching element; in this case, the intermediate plate may be configured such that, when it is clamped between said matching element and the surface of the interface body, it is abutted under push against the interface body (in particular against a wall thereof) under the push of said cones.

According to an aspect of the present invention, the connection element may comprise a tubular-shaped body with a thread (for instance external and for instance of the SMA type).

According to an aspect of the present invention, the connection element may be connected to the interface body in a removable manner, for instance by means of screws, although in other cases it may be made integral with said interface body.

According to an aspect of the present invention, the interface body and the matching element can be made of a zinc alloy and can be obtained by a die-casting process. The material may vary, for instance brass or an alloy thereof, or aluminium or an alloy thereof, or any other suitable material can be used.

Summing up, the present invention has many advantages: for example, the matching element can slide with great stability in the connection element, and/or the presence of centering means.

In relation to the centering means, in a generally way, the present invention the connection comprises centering means configured to engage with respective reference portions of the board and, when the matching element and the interface body are fastened with each other, to force said board in a reference position. The centering means are different from the screws adapted to fasten the interface body and the matching element to each other, and are components precisely formed to force the board in the reference position.

In one embodiment, the centering means comprise first centering means, in particular when said first centering means are formed on the matching element and the plate is not present, or second centering means, in particular when said second centering means when they are formed in the intermediate plate.

The first centering means may include at least two protruding elements that protrude from the base plate of the matching element, said protruding elements being reference elements configured to engage with the corresponding reference portions of the board. For example, the protruding elements may be in the form of cones which are formed around the threaded holes of the base plate and are configured to be inserted into respective holes of the board, in particular holes for the passage of screws, or may be the form of protruding pins configured to engage with corresponding reference holes formed on the board (wherein said protruding pins may have at least their free end portion having a conical or tapered shape).

As a preferred alternative, the centering means may be formed in the intermediate plate (which is arranged between the base plate of the matching element and a surface of at least one shoulder of the interface body, said intermediate plate comprising through-holes adapted to allow the passage of the screws for fastening the interface body and the matching element with each other), and therefore are the above-mentioned second centering means. The second centering means are configured to engage with respective reference portions of the board and to force said board in a reference position when the matching element and the interface body are fastened with each other and said board is placed between said intermediate plate and the surface of said interface body. For example, the second centering means of the intermediate plate may include a pair of cones configured to be inserted into respective holes of the board, said cones being formed around the through-holes of said intermediate plate, or the second centering means may be a pair of protruding pins configured to engage with corresponding reference holes formed on the board, said protruding pins being placed in respective positions that are shifted with respect to the through-holes of said intermediate plate, and wherein said protruding pins have at least their free end portion having a conical or tapered shape.

The present invention also relates to a method for producing a connector by die casting, comprising the step of arranging at least one first die and one second die, wherein the first die is shaped to define an impression of an interface body comprising a through-hole for the passage of a signal-transmission portion (or transmission line), and wherein the second die is shaped to define an impression of a matching element adapted to mechanically couple with the interface body and to determine, when coupled with said interface body, the clamping of a board associable with said connector and adapted to receive the signal of the signal-transmission portion; there is then the step of injecting molten metal into said first die and into said second die, and, after injecting, the step of extracting the interface body formed in the first die and the matching element formed in the second die.

According to an aspect of the present invention, the method may comprise a step of arranging a third die shaped to define an impression of an intermediate plate to be placed, after its extraction, between the matching element (in particular its base plate) and a surface of at least one shoulder of the interface body.

According to an aspect of the present invention, the method may comprise the step of modifying at least one die by modifying and/or adding and/or removing one or more dowels to define, when molten metal is injected into said die, protruding elements on the matching element and/or on the intermediate plate or to vary protruding elements.

This is very advantageous, because the die-casting process allows to form in a very effective way the protruding elements, for example the cones of the pins, which is not possible with other methods.

According to an aspect of the present invention, the second die may be shaped so as to mold, when molten metal is injected, a pair of coupling elements extending from a base plate.

According to an aspect of the present invention, the first die may be shaped so as to mold, when molten metal is injected, respective housing seats in the interface body.

According to an aspect of the present invention, the molten metal may be a zinc alloy injected (for instance pressure injected) into the cavity of the die.

According to an aspect of the present invention, the material may be brass or an alloy thereof, or aluminium or an alloy thereof.

The features and advantages of the connector and method of the present invention will become apparent from the following description of an embodiment thereof given by way of illustrative and non-limiting example with reference to the appended drawings.

### BRIEF DESCRIPTION OF THE DRAWINGS

In these drawings:

FIG. 1 shows a perspective view of a connector according to an embodiment of the present invention;

FIGS. 2A-2D show views of a connector according to an embodiment of the present invention;

FIGS. 3A-3D show views of the connector of FIGS. 2A-2D connected to a board on which a microstrip line is formed;

FIGS. 4A-4D show views of the connector of FIGS. 2A-2D connected to a board on which a microstrip line is formed, wherein the board has slotted openings;

FIGS. 5A-5D show views of a connector according to another embodiment of the present invention;

FIGS. 6A-6D show views of the connector of FIGS. 5A-5D connected to a board on which a microstrip line is formed;

FIGS. 7A-7D show views of the connector of FIGS. 5A-5D connected to a board on which a microstrip line is formed, wherein the board has slotted openings;

FIGS. 8A-8D show views of a connector according to another embodiment of the present invention;

FIGS. 9A-9D show views of the connector of FIGS. 8A-8D connected to a board on which a microstrip line is formed;

FIGS. 10A-10D show views of a connector according to another embodiment of the present invention;

FIGS. 11A-11D show views of the connector of FIGS. 10A-10D connected to a board on which a microstrip line is formed; and

FIGS. 12A-12D show views of the connector of FIGS. 10A-10D connected to a board on which a microstrip line is formed, wherein the board has slotted openings.

### DETAILED DESCRIPTION

With reference to these figures, reference number 100 globally and schematically indicate a connector made according to the present invention, said connector 100 being made according to a related method.

It should be noted that the figures represent schematic views and are not drawn to scale, but are instead drawn so as to emphasise the important features of the invention. Furthermore, in the figures, the various components are represented schematically, their shape being able to vary depending on the desired application. It should also be noted that, in the figures, identical reference numbers refer to elements identical in shape or function. Finally, particular features described in relation to an embodiment illustrated in a figure may also be used for the other embodiments illustrated in the other figures.

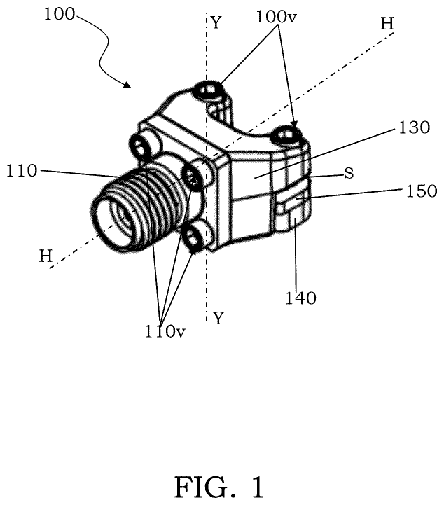

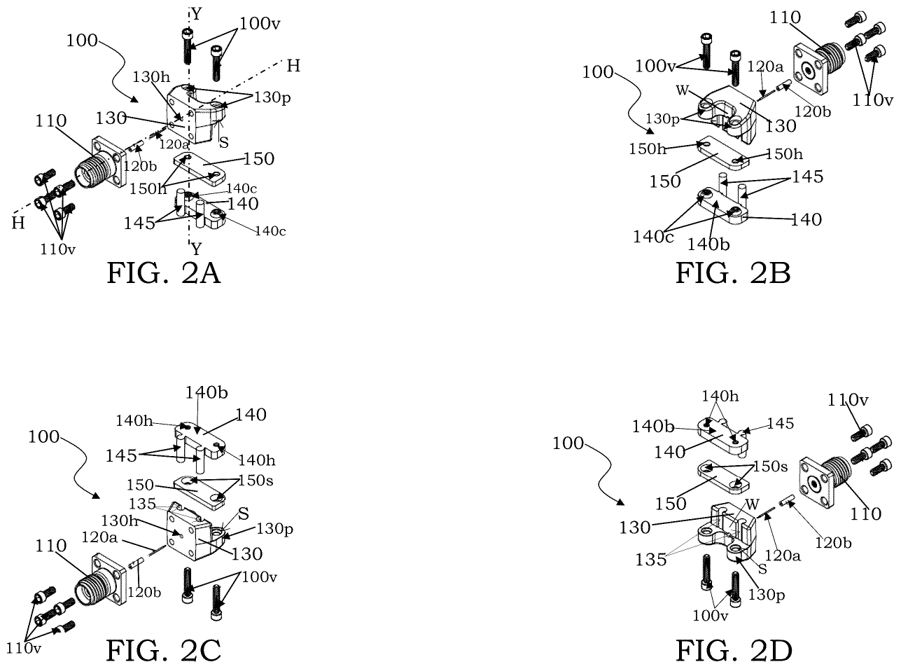

All of the main components of the invention will be highlighted by appropriate references in FIGS. 1 and 2A-2D, whereas the other figures will only show the references for the particular aspects described in relation to those other figures, in order not to complicate the representation of the invention.

Clearly, some technical details of the invention may be replaced by other technically equivalent details without departing from the scope of the claimed invention, as it will be apparent to a person skilled in the art.

It should also be noted that, when sequences of process steps are illustrated, they do not necessarily follow the sequence indicated, as these steps may, in some cases, be reversed.

The connector 100 of the present invention is preferably used for the connection with coaxial cables carrying signals in the microwave range, although the examples given in the following description are only illustrative and are in no way limiting of the scope of the present invention. Indeed, although the examples illustrated herein below provide for the interfacing of the connector 100 with a microstrip line for the transmission of microwave signals, the present invention is not limited to this application.

Advantageously, the connector 100 of the present invention is produced by a die-casting process and is therefore characterised by lower production costs and high reproducibility compared to techniques involving the use of numerically controlled machines. Details of this production method will be provided later in this description, whereas the following paragraphs will focus on the particular structure of the connector 100, which has significant advantages compared to the known solutions.

As illustrated in FIG. 1, first of all the connector 100 comprises a connection element (indicated with reference number 110) configured to couple with a coaxial cable (not shown in the figures as it is conventional), in particular to couple with a connection end formed at the end of said coaxial cable.

The connection element 110 may be a commercially available connector and will not be detailed in order not to burden the present description; in general, it may have a tubular-shaped body with a threaded portion for coupling with the connection end with which the coaxial cable ends, although the present invention is not limited by the particular type of connection. It should also be noted that the threaded portion for coupling the connection element 110 to the connection end of the cable may be of the male or female type, without limiting the scope of the present invention.

The aforementioned tubular body may extend from a plate that allows it to be connected to the remaining components of the connector 100, as it will be detailed herein below.

As it is known in the field, the body of the connection element 110 encloses a signal-transmission portion, which comprises a central conductive pin 120a (i.e., the conductive core) surrounded by an insulating sheath 120b in the form of a dielectric coating.

Hereinafter, for convenience, the term “signal-transmission portion” may indicate and therefore be synonymous of conductive pin and may be identified with the same reference number 120a, even if it is not necessarily in the form of a pin.

The connector 100 also comprises a flange element (hereinafter also referred to as “interface body” or “transition block” and identified with reference number 130). The interface body 130 may be connected to the connection element 110 and comprises a through-hole (reference number 130h), in particular formed in a central portion thereof, adapted to allow the passage of the signal-transmission portion and from which the conductive pin 120a protrudes to allow the connection of the latter to a microstrip line formed on a printed circuit board (herein indicated with reference number 200). The interface body 130 is therefore configured to electrically connect the conductive pin 120a (more generally, the signal-transmission portion) to the microstrip line to which the high-frequency signal is to be transmitted, which then passes through a substantially central position of the connector 100.

For ease of illustration, the direction along which the conductive pin 120a develops, and therefore the direction along which the signal is transmitted (and also the development direction of the body of the connection element 110) is defined as the “longitudinal axis H-H”, said longitudinal axis H-H also being understood as an symmetry axis of the connector 100, axis which therefore passes through the signal-transmission portion (which, as seen, is located in a substantially central position of the connector 110).

In an embodiment, the connection element 110 is connected to the interface body 130 in a removable manner, for instance by means of screws 110v, although this is not strictly necessary and other configurations may fall within the scope of the present invention (in other cases, indeed it may be formed integral with the interface body 130).

A matching element (hereinafter also referred to as “carriage” and indicated with reference number 140, also referred to as “clamping element”) is also provided, which is configured to mechanically couple (in particular, connect in a removable manner) with the interface body 130 and, when connected thereto, determine the clamping of the board 200, which is adapted to receive the signal from the conductive pin 120a protruding from the through-hole 130h of said interface body 130.

Advantageously according to the present invention, the matching element or clamping element 140 comprises at least two coupling elements (both indicated with reference number 145) and the interface body 130 comprises at least two respective housing seats (both indicated with reference number 135) configured to receive and engage with said coupling elements 145. The housing seats 135 formed in the interface body 130 are therefore configured to allow the guided sliding of the coupling elements 145 therein, so that the matching element 140 behaves like a carriage that slides telescopically inside these housing seats 135.

In other words, the housing seats 135 are two guides that allow the guided sliding of the matching element 140, so that the relative movement in the transversal direction (i.e. along a direction orthogonal to the longitudinal axis H-H) between said matching element 140 and the interface body 130 is reduced to a minimum. This solution is therefore mechanically very robust thanks to the presence of the double guide, which allows the matching element 140 to be perfectly guided, eliminating the transversal clearance (which is reduced to the sole minimum machining tolerances).

As visible from the figures, the coupling elements 145 and the housing seats 135 are arranged symmetrically in respective positions offset from the through-hole 130h of the interface body 130; the positions of these elements are therefore at a given distance from said through-hole 130h, this distance being variable according to requirements and/or needs.

In a preferred embodiment of the present invention, the matching element 140 comprises a base plate (reference number 140b) from which the coupling elements 145 extend. Threaded holes 140h are also formed in said base plate 140b to accommodate screws (indicated with reference number 100v) adapted to fasten the interface body 130 and said matching element 140 to each other, thus allowing the clamping of the board 200.

In general, the housing seats 135 are recesses formed in the interface body 130 and the coupling elements 145 are in the form of projections which are housed in said recesses; as illustrated in the figures, said coupling elements 145 and said housing seats 135 therefore have shapes complementary to each other.

In a particular and preferred embodiment, the coupling elements 145 are in the form of pins extending from the base plate 140b along a vertical axis (indicated as “Y-Y axis”) substantially orthogonal to said base plate 140b.

The pins preferably have a cylindrical shape extending along the aforementioned Y-Y axis (as illustrated in FIGS. 2A-2D, 8A-8D and 10A-10D) and the guides are also cylindrical-shaped, although other less preferred configurations may fall within the scope of the present invention.

Advantageously, by means of the aforementioned pins (and more generally by means of the coupling elements 145), the matching element 140 is telescopically connected with the interface body 130, so that it can slide in the guides until it is positioned in the correct working position, with the possibility of modifying the relative distance between said components.

More specifically, according to the present invention, the position of the base plate 140b with respect to the interface body 130 can be defined based on the length of the screws 100v that can be screwed into the threaded holes 140h, with consequent adjustment of the extent of insertion by sliding of the coupling elements 145 inside the housing seats 135; by way of example, if more space is required between said components (for instance to accommodate a thicker board 200), longer screws 100v can be used, whereas in other applications shorter screws 100v can be used. In other words, the connector 100 is configured to allow adjustment of the penetration degree of the matching element 140 into the interface body 130, with consequent selection of the most appropriate length of the screws 100v. This is particularly advantageous as the connector 100 is thus able to couple with various types of boards 200 (for instance boards of different thicknesses) simply by varying the position of the matching element 140 within the guides and using screws 100v of different length, but without the need of using a different type of connector, as is the case in known solutions.

Still more specifically, the interface body 130 comprises a wall (indicated with reference W), in which the housing seats 135 and the through-hole 130h are formed, as well as a pair of housings 130p for the screws 100v, which protrude from the wall W and define a pair of shoulders with respective abutting or matching surfaces (reference S, generically indicated herein below as “surfaces”). As seen above, the distance between the base plate 140b and the surfaces S is variable and adaptable based on the several applications.

It should be noted that the figures show a preferred embodiment in which there are two shoulders with two surfaces S, although the present invention is not limited thereto and there could also be a single shoulder protruding from the wall W with a single surface S, this shoulder bearing the two housing seats for the screws 100v.

Furthermore, in an embodiment of the present invention, the connector 100 comprises centring means configured to engage with respective reference portions of the board 200 and to force, when the matching element 140 is constrained to the interface body 130, said board 200 in a reference position, in particular in a central position in which the position of the conductive pin 120a and of the microstrip formed on said board 200 are coincident (in particular, they are both along the same axis, for instance the symmetry axis H-H). The centring means are therefore references on the connector 100 that are adapted to couple with the corresponding reference portions on the board 200 to perform the centring thereof, bringing the microstrip precisely in a central position where it is superimposed and connected to the conductive pin 120a, for optimal signal transmission.

Specifically, the present invention provides different types of centring means which will be described herein below.

With reference to FIGS. 2A-2D, there are first centring means (reference 140c) formed on the matching element 140; more specifically, the first centring means 140c include at least two protruding elements (still indicated with reference number 140c) from the base plate 140b, said protruding elements 140c acting as reference elements configured to engage with the corresponding reference portions on the board 200, as seen above; in this case, the reference portions on the board 200 coincide with the holes (reference number 200h) formed thereon for the passage of the fixing screws 100v.

In a particular embodiment, the aforementioned protruding elements 140c are in the form of cones formed around the threaded holes 140h of the base plate 140b and are configured to be inserted into respective holes 200h of the board 200, where the maximum diameter of said cones coincides with the diameter of the holes 200h of the board 200. For ease of illustration, these cones will also always be indicated with the reference number 140c.

In any case, it should be noted that if the position of the holes 200h formed in the board 200 does not exactly coincide with the expected position, it is preferable to mount the matching element 140 rotated, i.e. with the cones 140c facing outwards in the opposite direction relative to the board 200, as it will be described in more detail herein below. In other words, in some cases, it may be preferable not to insert the cones 140c directly into the holes of the board 200 (since the position of the holes 200h may not coincide with the position of said cones 140c), for instance by turning the matching element 140 or using said cones 145 to correctly position an intermediate plate, as it will be described herein below.

More specifically, with reference to FIGS. 2A-2D, in a preferred embodiment of the present invention, the connector 100 comprises an intermediate plate (indicated with reference number 150) arranged between the base plate 140b of the matching element 140 and the surface S of at least one shoulder of the interface body 130. The intermediate plate 150 comprises through-holes 150h for the passage of screws 100v for fastening the interface body 130 and the matching element 140 with each other. The intermediate plate 150 has the important purpose of bringing the board 200 into contact with the wall W of the interface body 130, so as to avoid unwanted losses in the radio frequency signal.

More specifically, as mentioned above, the matching element 140 may comprise the aforementioned cones 140c protruding from the base plate 140b and formed around the threaded holes 140h; the intermediate plate 150 may instead comprise suitable seats (indicated with reference number 150s) configured to engage with said protruding cones 140c. In this way, when the intermediate plate 150 is clamped between the matching element 140 and the surface S of the shoulders of the interface body 130 (and therefore when the cones 140c are inserted inside the respective seats 150s of said intermediate plate 150), it is abutted under push against the interface body 130, in particular against its part W, under the push of said cones 140c.

Still more specifically, the intermediate plate 150 has dimensions slightly larger than the corresponding dimensions of the base plate 140b of the matching element 140, so as to compensate for any clearance that may occur in the longitudinal direction (while, as mentioned above, the clearance in the transversal direction is minimised by the presence of the guides), and it is brought into abutment against the wall W of the interface body 130 when the components of the connector 100 are constrained to each other, and thus passes from a configuration in which it is not constrained to a constrained configuration in which one of its sides is against said wall W. Suitably, in order to obtain this advantageous effect, the seats 150s formed in the intermediate plate 150, with which the cones 140c are in engagement, are preferably formed in an eccentric position.

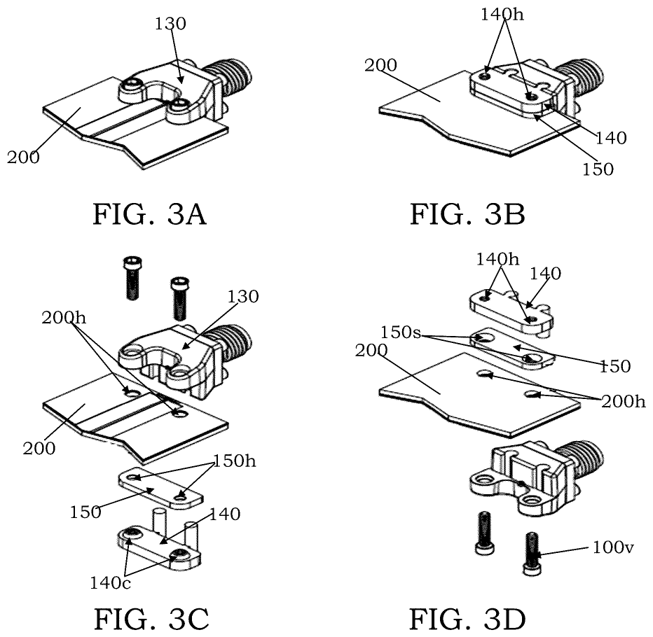

As mentioned above, in the absence of the intermediate plate 150, there is a risk that the board 200 will move in the longitudinal direction (i.e. along the H-H axis), forming a small gap which, however small, would act as a notch filter, with negative consequences on the transmitted signal. The cones 140c formed on the matching element 140 are therefore advantageously usable to easily position the board 200 in the most optimal configuration, forcing the positioning of the intermediate plate 150, which is suitably sized and which drags said board 200 against the part W, with the advantages indicated above; FIGS. 3A-3D show the connector 100 of FIGS. 2A-2D which a board 200 is associated with in the manner indicated above.

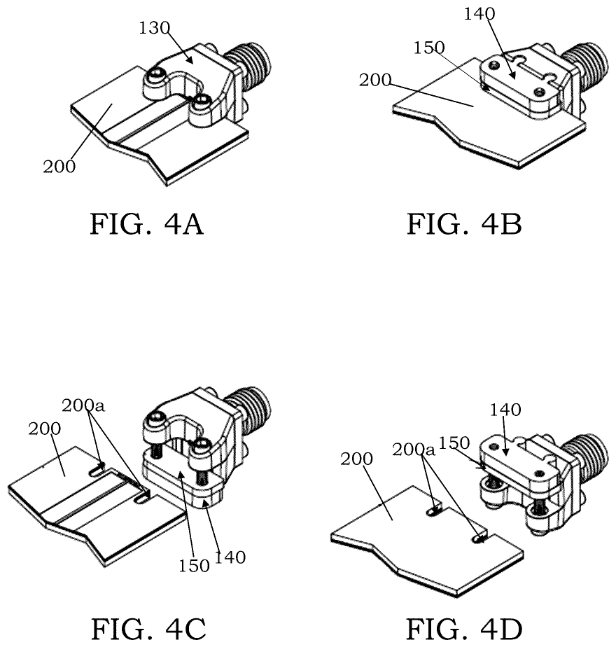

In order to facilitate the assembly and disassembly of the board 200 on the connector 100, it is possible to make said board 200 with slotted openings (indicated with reference number 200a) instead of the aforementioned holes 200h, and it is therefore possible to insert the screws 100v into these slotted openings 200a without necessarily completely disengaging the matching element 140 from the interface body 130, as illustrated in FIGS. 4A-4D. The slotted openings 200a are essentially recesses formed at the side of the board 200 facing the wall W of the interface body 130 and allow the board 200 to be inserted by simply inserting the screws 100v into said slotted openings 200a, with the screws 100v sliding inside them. This is possible thanks to the advantageous configuration of the connector 100 according to the present invention, with the possibility of telescopic sliding of the matching element 140 inside the guides formed in the interface body 130, without bulkiness in the central position and without the need to completely remove the matching element 140, which is simply moved by sliding into the guides and there is an enormous range of movement of said component.

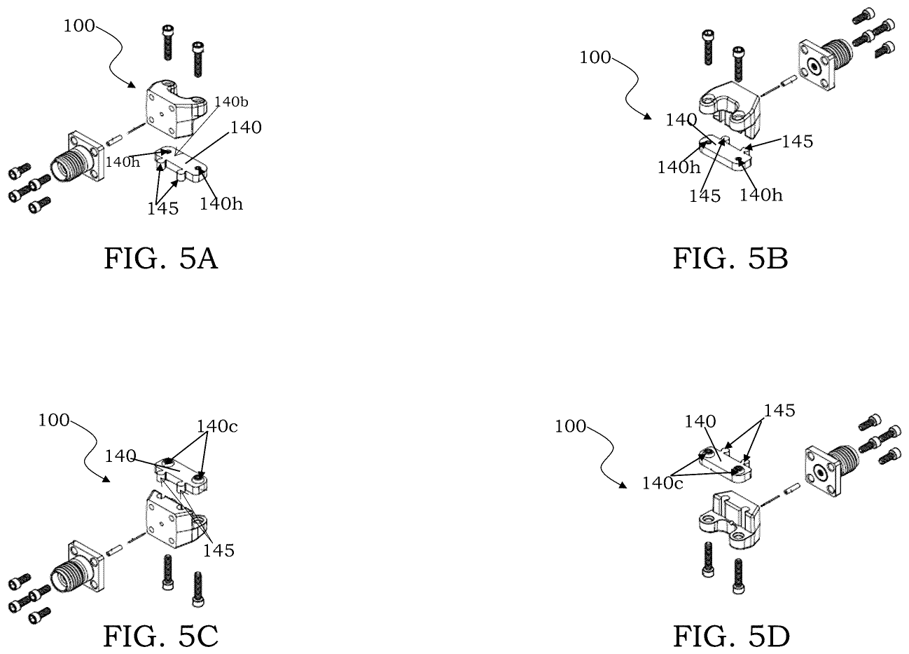

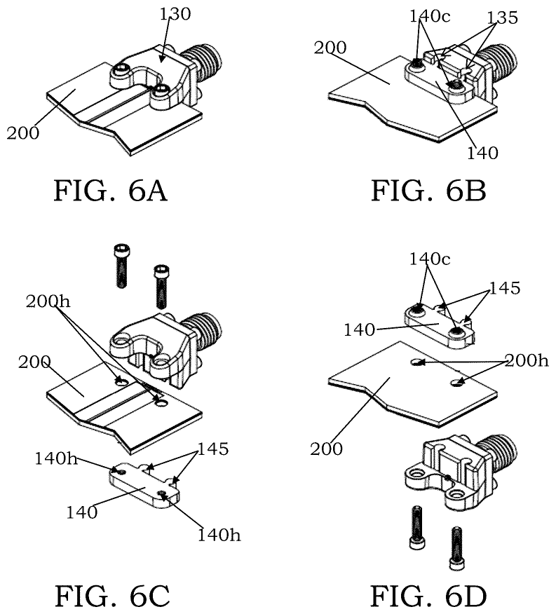

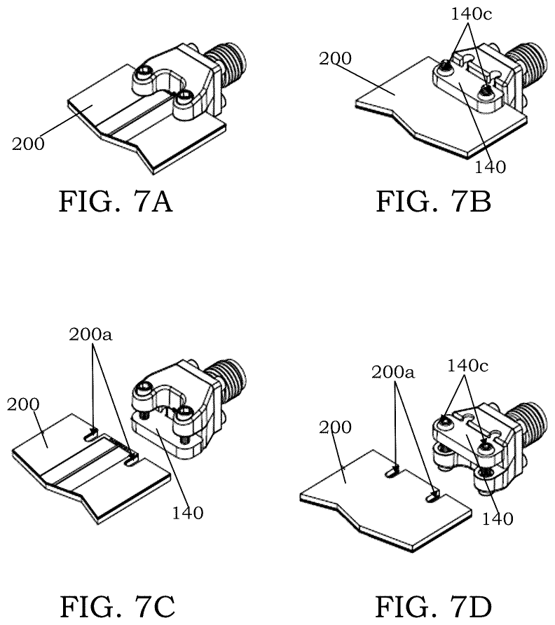

As mentioned above, with reference to FIGS. 5A-5D, for instance, if the intermediate plate 150 is not used, the matching element 140, which bears the protruding cones 140c, can be mounted in a reverse manner, i.e. with said cones 140c facing towards the direction opposite the surface S of the interface body 130. In this case, the coupling elements 145 may be in the form of elements protruding from the base plate 140b with a thickness substantially equal to that of said plate (and therefore without extending vertically but protruding in a direction contained in the plane in which the base plate 140b lies), so as not to create bulkiness of the connector 100 as a whole. FIGS. 6A-6D show different views of the connector 100 of FIGS. 5A-5D interfaced to a board 200, in which the matching element 140 is mounted rotated with the protruding cones 140c facing outwards. As already seen in relation to FIGS. 4A-4B, in order to facilitate assembly and disassembly, it is also possible in this case to form slotted openings 200a on the board 200 instead of through-holes 200h, as shown in FIGS. 7A-7D. This embodiment allows the connector 100 to also be used with boards 200 that can be mounted on other connectors produced by other companies, with the advantage in this case of the guided constraint of the matching element 140 and the possible use of the cones 140c (which may also not be used by turning the matching element 140 as seen above, for instance, if the position of the holes 200h coincides with that of these cones 140c).

In another embodiment, the connector 100 also comprises second centering means, with the purpose of centering the board 200 as correctly as possible (similarly to the cones 140c). In particular, while the first centering means 140c (usable for centering the board or for positioning the intermediate plate 150) are formed on the matching element 140, the second centering means (herein identified with reference number 150c) are formed on the intermediate plate 150.

As seen above, said centring means 150c are configured to engage with respective reference portions of the board 200 (for instance with the aforementioned holes 200h of the latter for the passage of the screws 100v) and to force said board 200 in a reference position (in particular in a position in which the microstrip is at the centre of the connector 100) when the matching element 140 is constrained to the interface body 130 and said board 200 is arranged between said intermediate plate 150 and the surface S of the shoulders of said interface body 130.

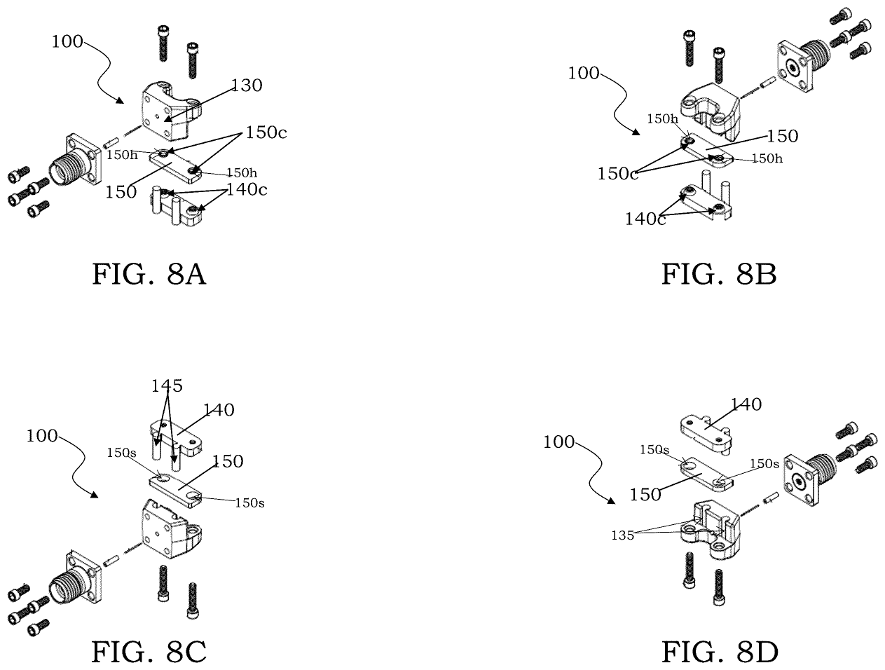

In the embodiment illustrated in FIGS. 8A-8D, the second centering means 150c of the intermediate plate include a pair of cones (still indicated with reference number 150c) configured to be inserted into the respective holes 200h of the board 200, similarly to what has been seen for the cones formed on the matching element 140 and shown in FIGS. 2A-2D and 3A-3D. In particular, the cones 150c are formed around the through-holes 150h of the intermediate plate 150 and are configured to engage with the holes 200h of the board 200, thus ensuring its optimal centring automatically when the screws 100v are screwed in and the board 200 is tightened in the connector; in an embodiment, the maximum diameter of said cones 150c substantially coincides with the diameter of the holes 200h of the board 200.

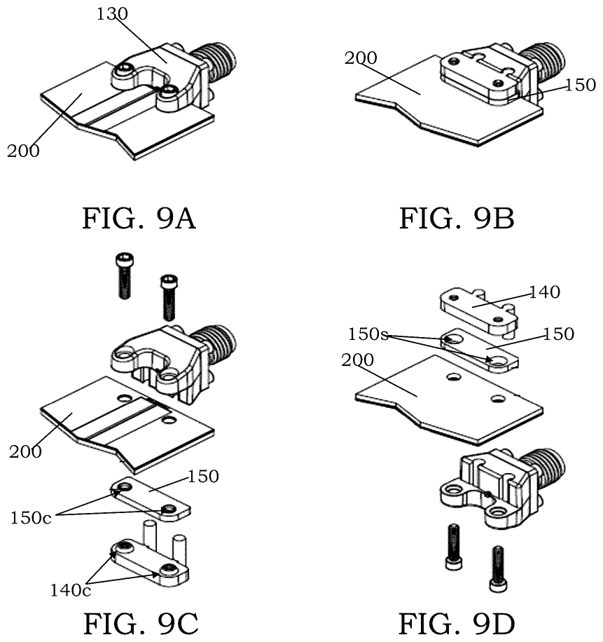

FIGS. 9A-9D show the connector of FIGS. 8A-8D coupled to a board 200, with the cones 150c inserted in the holes 200h of said board 200.

In general, the second centering means may also have the function of promoting, in addition to centering, the aforementioned effect of dragging the board 200 against the wall W of the interface body 130.

As already discussed above in relation to the cones 140c formed on the matching element 140, also in this case, in order to avoid situations in which the position of the cones 150c does not perfectly coincide with that of the holes 100h preformed on the board 200 (as it may occur in the case of pre-existing boards and possibly already mounted on other connectors from other companies), embodiments may be provided in which said cones 150c are not present.

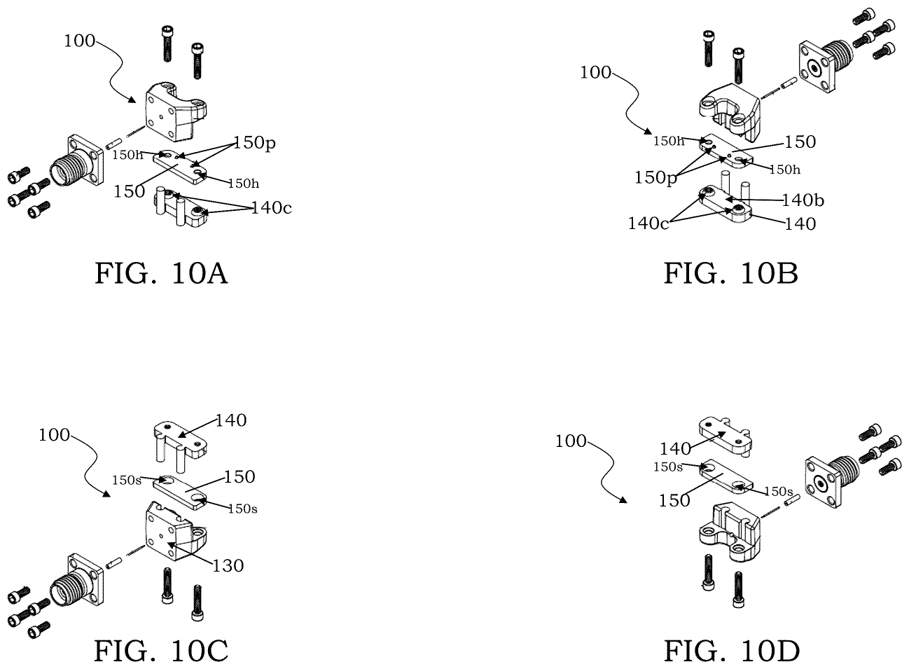

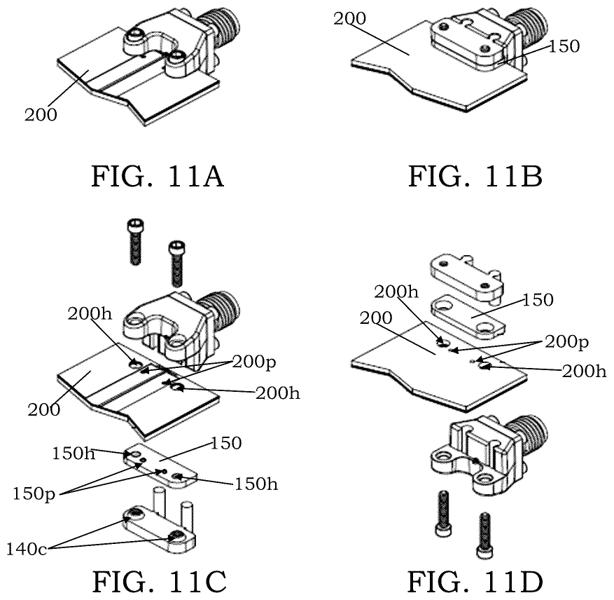

For instance, according to an advantageous embodiment of the present invention illustrated in FIGS. 10A-10D and 11A-11D, the centring means of the intermediate plate 150 are formed by a pair of pins protruding from said intermediate plate 150 (indicated with reference number 150p), which are configured to engage in corresponding reference holes (indicated with reference number 200p) formed on the board 200 (which therefore act as alternative reference portions on the board 200). More specifically, in this case, it is provided to make the reference holes 200p on the board 200 using suitable templates, said reference holes 200p being different from the holes 200h which allow the passage of the screws 100v; the position of the protruding pins 150p is then suitably defined so as to correspond to the position of the aforementioned reference holes 200p. In this case, by defining the position of the reference holes 200p on the board 200 precisely, the aforementioned drawbacks due to the positioning of the holes 200h for the passage of the screws 100v are avoided, and an optimal centring is achieved.

The protruding pins 150p are then arranged in respective positions shifted with respect to the through-holes 150h of the intermediate plate 150, for instance in a position closer to the centre of said intermediate plate 150.

It should be noted that the protruding pins 150p have at least their free end portion of conical or more generally tapered shape, so as to create a guide and facilitate their insertion into the reference holes 200p of the board 200, while their base diameter (i.e. the diameter of their base at the intermediate plate 150, for instance a cylindrical-shaped base) is substantially equal to the diameter of said reference holes 200p.

This embodiment has the advantage that the centring of the board 200 is very precise and requires the formation of the two additional holes 200p on said board 200, whereas the previous embodiment also allows adaptation to already existing boards that can be mounted on other connectors from other companies.

This embodiment may then be combined with the previous ones to achieve the appropriate positioning of the intermediate plate 150 by means of the cones 140c (and more generally the protruding elements) formed on the matching element 140 and engaging with the seats 150s, with the aim of pushing the board 200 against the wall W of the interface body 130.

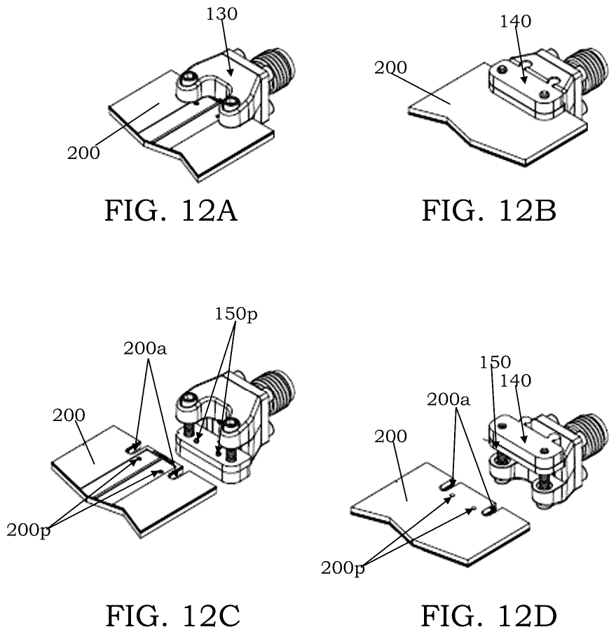

As seen above, in this case too, it is possible to facilitate the assembly and disassembly of the board 200 by forming slotted openings 200a, as illustrated in FIGS. 12A-12D. In the case of slotted openings 200a, the protruding pins 150p are the preferred centring means (and in some cases the only possible ones).

It should also be noted that, advantageously, the interface body 130, the matching element 140, and the intermediate plate 150, and more generally all main components of the connector 100, are made of a zinc alloy (for instance Zama) and are obtained by a die-casting process, as it will be extensively discussed in the following paragraphs. Obviously, the present invention is not limited by the material used, and other materials may also be used, such as brass or an alloy thereof, or aluminium or an alloy thereof.

Indeed, the present invention also relates to the producing method of the connector 100, said method differing from the methods used in the prior art. In particular, said connector 100 is made by a die-casting process comprising the following steps.

First of all, a series of dies is arranged for making the above components.

In particular, there is a first die shaped so as to define the impression of the interface body 130, defining in said impression the body of said component with the through-hole 130h for the passage of the conductive pin 120a, as well as a second die shaped so as to define the impression of the matching element 140 adapted to mechanically couple with the interface body 130 and to determine, when coupled therewith, the clamping of the board 200 between said components.

In particular, the second die is shaped so as to form (mold), when molten metal is injected thereinto, the coupling elements 145 extending from the base plate 140b, whereas the first die is shaped so as to form (mold), when molten metal is injected, the respective housing seats 135 in the interface body 130, i.e. the components that have been detailed above.

A third die shaped to define the impression of the intermediate plate 150 to be arranged between the matching element 140 and the surface S of the shoulders of the interface body 130 may also be arranged.

In an embodiment, a single multi-cavity die may also be used, such that the first, second, and third dies are part of a single die, without any limitation of the scope of the present invention. In other words, the terms “first”, “second”, and “third” dies may also indicate portions of a same die, without the present invention being limited by this terminology.

It should also be noted that more than one first/second/third dies may be used. In an embodiment, four cavities may be provided for the formation of four interface bodies 130 simultaneously (and therefore, from another point of view, four first dies may be provided), into which molten metal is supplied from a central channel that branches into four branches (or casting branches); each casting branch can then have two casting connections for a total of eight gates. Obviously, this configuration is only indicative and not limiting of the scope of the present invention, and any suitable configuration can be adopted.

The above-mentioned dies then provide the shape of the desired components. In general, a die-casting machine comprises a base on which at least one fixed plate is mounted, which carries at least one first half-die (which is therefore a fixed half-die); there is then a movable plane that can be translated and guided on the base, said movable plane bearing at least one second half-die (movable half-die): the half-dies are formed by two complementary parts which, by coupling to each other, define an impression that corresponds to the shape of the piece to be obtained by die casting. The aforementioned first, second, and third dies can therefore be formed as indicated above.

The die-casting machine further comprises an injection unit for feeding molten metal into the die when the two half-dies are coupled; the injection unit is supported by the base and can be placed opposite an external face of the first fixed plane.

Once the dies have been arranged, a step of injecting molten metal into said dies follows. As previously discussed, the molten metal is a zinc alloy (for instance Zama) injected under pressure into the cavity of the die. The present invention is not limited by the material used, and other materials may also be used, such as brass or an alloy thereof, or aluminium or an alloy thereof, or any material suitable for use in the process described herein.

In an embodiment, this process takes place under vacuum, without this limiting the scope of the present invention.

Finally, there is a step of extracting the components from the various dies, before assembling the connector 100.

As seen above, different shapes may be provided for the matching element 140 and especially for the intermediate plate 150; in this regard, it is possible to modify one or more of the above-mentioned dies by modifying and/or adding and/or removing one or more dowels. In this way, it is possible to define, when molten metal is injected into said die, on the matching element 140 and/or on the intermediate plate 150 various protruding elements, such as cones or protruding pins for automatic centring of the board 200 and/or its dragging in abutment against the part W of the interface body 130, as described above with reference to the various figures.

It should also be noted that the parameters of the above process are optimised in order to reduce turbulence in the fluid injected towards the cavities and to avoid the formation of undesirable porosity, for instance at the through-hole 130h. For instance, the diameter of the tip is chosen between 6 mm and 6.5 mm, the casting branches have an increased cross-section, connecting radii are provided at the various joints, and the casting attachments have an optimised shape; in general, studies are being carried out to optimise the dies and, in general, the production process described herein for the connector 100.

In conclusion, the present invention thus brilliantly overcomes the technical problem, providing the above-mentioned connector and solving all of the prior art drawbacks.

Advantageously, according to the present invention, the matching element (or carriage or clamping element) is inserted into the interface body in a perfectly guided manner, without transversal clearance (apart from minimal manufacturing tolerances): this guarantees excellent mechanical strength of the connector and also facilitates the centring of the board associated with that connector.

The clearance in the longitudinal direction is compensated by the presence of the intermediate plate, which has slightly larger dimensions than the plate of the matching element and is suitably dragged in abutment against the wall of the interface body, thus avoiding losses in the transmitted signal. The use of cones on the matching element is particularly advantageous, cones which engage with eccentric seats on the intermediate plate for automatic dragging of the board against the wall of the interface body, taking up the clearance in the longitudinal direction (and also facilitating the centring of the board).

The pins (more generally the connection elements) of the matching element and the guides of the interface body are formed laterally with respect to the central through-hole through which the signal passes, so as to allow the telescopic sliding of said pins without bulkiness, which would not be possible with a single central guide. Indeed, in known solutions that provide a single central connection element, in addition to a loose connection with poor mechanical strength, there is a central bulkiness that does not allow the aforementioned telescopic sliding of the matching element. According to the present invention, the matching element remains in the guide even when boards with high thicknesses are used: it is always guided and has a wide range of possible heights.

As mentioned, the guided insertion of the matching element also aids in the precise centring of the printed circuit board on which the microstrip line is formed.

However, specific centring means are provided for the precise automatic centring of the board.

Suitably, the connector of the present invention can be used both with existing boards (for instance mountable on connectors from other companies) and with customised boards, where it is sufficient to modify the intermediate plate and/or modify the distance between the matching element and the interface body, thanks to the fact that it can slide inside the guides by a significant distance.

Furthermore, the manufacture of the connector by means of the die-casting process has advantages in terms of reduction in the production costs, as well as high repeatability, which cannot be achieved by the known processes through numerically controlled machines. This method also allows obtaining connectors with complex shapes, for instance round, which cannot be obtained by other methods. For instance, the presence of a connector with a double guide, especially circular-shaped, would be extremely complicated through methods other than the one proposed: it can therefore be seen once again that the production of a connector such as the one seen above by die casting is an absolutely new feature.

The connector of the present invention is therefore a so-called “End-Launch” connector that allows the interfacing (or transition) of high-frequency signals from cables, in particular coaxial cables, to boards, for various applications, such as telecommunications or test applications.

Obviously, a person skilled in the art, in order to meet specific and contingent requirements, may make numerous modifications and variations to the connector and method described above, all of which are included within the scope of protection of the invention as defined by the following claims.

1. A connector comprising:
a connection element configured to couple with a coaxial cable, said connection element comprising a body that houses a signal-transmission portion;
an interface body connectable with the connection element and comprising a through-hole adapted to allow the passage of the signal-transmission portion coming from said connection element; and
a matching element configured to mechanically couple with the interface body and to cause, when it is coupled with said interface body, the clamping of a board which is associable with said connector and is adapted to receive a signal from the signal-transmission portion,
wherein the matching element comprises at least two coupling elements, and the interface body comprises at least two respective housing seats configured to receive and engage with the coupling elements, said housing seats being configured to allow a guided sliding of said coupling elements therein.

2. The connector according to claim 1, wherein the coupling elements and the housing seats are placed in respective positions with respect to the through-hole of the interface body, said respective positions being at a given distance from said through-hole.

3. The connector according to claim 1, wherein the matching element comprises a base plate from which the coupling elements extend, and threaded holes which are formed in said base plate and are adapted to receive screws adapted to fasten the interface body and said matching element with each other.

4. The connector according to claim 3, wherein the coupling elements are in the form of pins extending from the base plate along an axis which is substantially orthogonal to said base plate.

5. The connector according to claim 4, wherein the pins are shaped as a cylinder extended along said axis.

6. The connector according to claim 3, wherein the coupling elements are elements protruding from the base plate and have a thickness which is substantially equal to the thickness of said base plate.

7. The connector according to claim 3, wherein the matching element is telescopically connected with the interface body, with consequent adjustment of extent of insertion by sliding of the coupling elements into the housing seats, and wherein the position of the base plate of the matching element with respect to the interface body is defined by the screws screwed in the threaded holes formed in said base plate.

8. The connector according to claim 1, wherein the housing seats are recesses formed in the interface body, and the coupling elements are in the form of protrusions housed in said recesses.

9. The connector according to claim 1, wherein the coupling elements and the housing seats have shapes that are complementary to each other.

10. The connector according to claim 1, further comprising first centering means configured to engage with respective reference portions of the board and, when the matching element and the interface body are fastened with each other, to force said board in a reference position.

11. The connector according to claim 10, wherein the first centering means include at least two protruding elements that protrude from the base plate of the matching element, said protruding elements being reference elements configured to engage with the corresponding reference portions of the board.

12. The connector according to claim 11, wherein said protruding elements are in the form of cones which are formed around the threaded holes of the base plate and are configured to be inserted into respective holes of the board, in particular holes for the passage of screws, or
wherein said protruding elements are the form of protruding pins configured to engage with corresponding reference holes formed on the board.

13. The connector according to claim 3, further comprising an intermediate plate arranged between the base plate of the matching element and a surface of at least one shoulder of the interface body, said intermediate plate comprising through-holes adapted to allow the passage of the screws for fastening the interface body and the matching element with each other.

14. The connector according to claim 13, wherein the intermediate plate comprises second centering means configured to engage with respective reference portions of the board and to force said board in a reference position when the matching element and the interface body are fastened with each other and said board is placed between said intermediate plate and the surface of said interface body.

15. The connector according to claim 14, wherein the second centering means of the intermediate plate include a pair of cones configured to be inserted into respective holes of the board, said cones being formed around the through-holes of said intermediate plate, or
wherein the second centering means of the intermediate plate are a pair of protruding pins configured to engage with corresponding reference holes formed on the board, said protruding pins being placed in respective positions that are shifted with respect to the through-holes of said intermediate plate, and wherein said protruding pins have at least their free end portion having a conical or tapered shape.

16. The connector according to claim 13, wherein the matching element comprises cones that protrude from the base plate and are formed around the threaded holes of said base plate, and wherein the intermediate plate comprises seats configured to engage with said cones of the matching element and is configured so that, when it is clamped between said matching element and the surface of the interface body, it is abutted against the interface body under the push of said cones.

17. The connector according to claim 1, wherein the interface body and the matching element are made of a zinc alloy, or of brass or an alloy thereof, or aluminium or an alloy thereof, and are obtained by a die-casting process.

18. A method for producing a connector, comprising steps of:
arranging at least one first die and second die, wherein the first die is shaped so as to define an impression of an interface body comprising a through-hole for the passage of a signal-transmission portion, and wherein the second die is shaped so as to define an impression of a matching element adapted to mechanically couple with the interface body and to cause, when it is coupled with said interface body, the clamping of a board that is associable with said connector and adapted to receive a signal from the signal-transmission portion;
injecting molten metal into said first die and into said second die; and
after the step of injecting, extracting the interface body formed in the first die and the matching element formed in the second die.

19. The method according to claim 18, further comprising a step of arranging a third die shaped so as to define an impression of an intermediate plate to be placed, after the step of extracting, between the matching element and a surface of at least one shoulder of the interface body; and/or
wherein the second die is shaped so as to mold, when the molten metal is injected, a pair of coupling elements extending from a base plate, and wherein the first die is shaped so as to mold, when the molten metal is injected, respective housing seats in the interface body.

20. The method according to claim 18, further comprising a step of modifying at least one die by modification and/or addition and/or removal of one or more dowels so as to define, when molten metal is injected into said die, protruding elements on the matching element and/or on the intermediate plate.
